(19) United States
(12) Patent Application Publication
(10) Pub. No.: US 2019/0084837 A1
(43) Pub. Date: Mar. 21, 2019

(54) BAUXITE GRINDING AIDS AND METHODS OF USE

(71) Applicant: Cytec Industries Inc., Princeton, NJ (US)

(72) Inventors: Airong SONG, Chappaqua, NY (US); Qi DAI, Stamford, CT (US); Lino MAGLIOCCO, Shelton, CT (US); Raymond Salvatore FARINATO, Norwalk, CT (US); Xin LI, Stamford, CT (US)

(21) Appl. No.: 16/134,072

(22) Filed: Sep. 18, 2018

Related U.S. Application Data
(60) Provisional application No. 62/559,851, filed on Sep. 18, 2017.

(51) Int. Cl. C01F 7/06; C08F 228/02; C08F 222/02; B02C 23/06

(52) U.S. Cl. CPC C01F 7/0613; B02C 23/06; C08F 222/02; C08F 228/02

(57) ABSTRACT

Bauxite grinding compositions that can significantly reduce the viscosity of bauxite slurry, which allow alumina refinery plants to increase throughput of bauxite grinding or pre-desilication. Described are processes to improve the grinding of a bauxite containing slurry in a Bayer process comprising: adding an effective amount of a bauxite grinding composition to the bauxite containing slurry before or during the grinding step or pre-desilication step, wherein the bauxite grinding composition comprises dextran, maltitol or a co-polymer.

### CROSS-REFERENCE TO RELATED APPLICATIONS

This application claims the benefit of U.S. Provisional Patent Application No. 62/559,851, filed Sep. 18, 2017, incorporated herein by reference in its entirety.

### FIELD OF THE INVENTION

This invention relates to chemical compositions for reducing bauxite slurry viscosity and improving bauxite grinding and handling in the alumina extraction process.

### BACKGROUND

Bauxite is the basic raw material for almost all manufactured aluminum compounds. In the course of production of aluminum compounds, bauxite can be refined to aluminum hydroxide and subsequently to alumina by the Bayer process, the Sinter process, and combinations thereof. The mineralogical composition of bauxite can impact the method of processing.

Bauxite is the generic name for naturally occurring ores that are rich in hydrated aluminium oxides. The ores are composed of gibbsite (Al₂O₃.3H₂O), boehmite (γ-AlO(OH)) and diaspore (α-AlO(OH)), combined with iron oxides, such as goethite (FeO(OH)) and haematite (Fe₂O₃), as well as other impurities such as kaolinite clays.

The Bayer process is a hydrometallurgical system for refining naturally occurring bauxite ores into anhydrous alumina, Al₂O₃. First proposed in 1888 by Karl Josef Bayer, it is currently the leading industrial means of alumina production. It is a multi-step, continuous process, comprising of grinding, pre-desilication, digestion, decantation, filtration, precipitation and calcination.

Before being digested with caustic soda, known as Bayer liquor, at high temperature and pressure to produce dissolved sodium aluminate, mined bauxite needs to be ground to fine solids first, and then to be pre-desilicated to convert most of clays to sodalite. During bauxite grinding and pre-desilication, a concentrated bauxite slurry in Bayer liquor, which normally contains 25-70% solids, is processed. The high viscosity of the concentrated bauxite slurry can generate a series of problems to alumina refineries, including poor grinding efficiency, high specific energy consumption for grinding, difficulty in handling and difficulty of pumping and transporting bauxite slurry, etc. As a result, it is very challenging for alumina refineries to increase the throughput of bauxite grinding or pre-desilication.

### SUMMARY OF THE INVENTION

Described herein are compositions that can significantly reduce the viscosity of bauxite slurry, which allow alumina refinery plants to increase throughput of bauxite grinding or pre-desilication. This results in increased alumina production, reduced energy consumption or a combination of both.

In one aspect, described herein is a process to improve (e.g., lowering the viscosity, etc.) the grinding and handling of a bauxite containing slurry in a Bayer process comprising: adding an effective amount of a bauxite grinding composition to the bauxite containing slurry before or during the pre-desilication step, wherein the bauxite grinding composition comprises dextran.

In yet another aspect, described herein is a process to improve (e.g., lowering the viscosity, etc.) the grinding and handling of a bauxite containing slurry in a Bayer process comprising: adding an effective amount of a bauxite grinding composition to the bauxite containing slurry, wherein the bauxite grinding composition comprises maltitol. In one embodiment, the effective amount of the bauxite grinding composition comprising maltitol is added to the bauxite containing slurry before or during the pre-desilication step

In a further aspect, described herein is a process to improve the grinding and handling of a bauxite containing slurry in a Bayer process comprising: adding an effective amount of a bauxite grinding composition to the bauxite containing slurry, wherein the bauxite grinding composition comprises a co-polymer comprising: a monomeric unit according to formula (I)

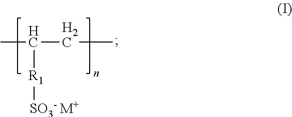

and

a monomeric unit according to formula (II)

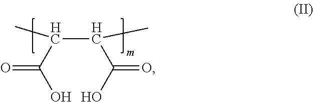

wherein R₁ is no group, O, C₁-C₁₀ alkyl, C₁-C₁₀ aryl, or C₁-C₁₀ arylalkyl; M+ is a group I metal ion or N(R⁴)₄+; R⁴ is hydrogen or an optionally substituted hydrocarbyl radical comprising from about 1 to about 20 carbons; “n” is an integer from 1-300; and “m” is an integer of from 1-10. In one embodiment, the effective amount of the bauxite grinding composition comprising the copolymer is added to the bauxite containing slurry before or during the pre-desilication step.

In one embodiment, the bauxite containing slurry comprises gibbsite, boehmite and diaspore. In one embodiment, the bauxite grinding composition is capable of reducing the viscosity of the bauxite containing slurry by at least 30%, 20%, or 10% as compared to the viscosity of a bauxite containing slurry absent the bauxite grinding composition.

In a further embodiment, the bauxite grinding composition can further comprise an anionic surfactant, a non-ionic surfactant, an amphoteric surfactant, a zwitterionic surfactant or a combination thereof.

In another aspect, described herein is an undigested aqueous mineral ore slurry comprising (1) a mineral ore and (2) dextran, maltitol, a copolymer comprising a monomeric unit according to formula (I) and a monomeric unit according to formula (II), or any combination thereof, in an amount effective to lower the viscosity in grinding the mineral ore. In some embodiments, the aqueous mineral ore slurry is an aqueous aluminum ore slurry.

### DETAILED DESCRIPTION OF INVENTION AND PREFERRED EMBODIMENTS

As used herein, the term “alkyl” means a saturated straight chain, branched chain or cyclic hydrocarbon radical, such as for example, methyl, ethyl, n-propyl, iso-propyl, n-butyl, sec-butyl, t-butyl, pentyl, n-hexyl, cyclohexyl, which, in the case of cyclic alkyl groups, may be further substituted on one or more carbon atoms of the ring with a straight chain or branched alkyl group and wherein any two of such substituents may be fused to form a polyalkylene group that bridges the two ring carbon atoms to which they are attached.

As used herein, the term “aryl” or “aromatic” means a monovalent unsaturated hydrocarbon radical containing one or more six-membered carbon rings in which the unsaturation may be represented by three conjugated double bonds, which may be substituted one or more of carbons of the ring with hydroxy, alkyl, alkenyl, halo, haloalkyl, or amino, such as, for example, phenoxy, phenyl, methylphenyl, dimethylphenyl, trimethylphenyl, chlorophenyl, trichloromethylphenyl, aminophenyl, and tristyrylphenyl.

As used herein, the terminology “(Cₘ-Cₙ)” in reference to an organic group, wherein “m” and “n” are each integers, indicates that the group may contain from m carbon atoms to n carbon atoms per group.

As used herein, the terminology “effective amount” in reference to the relative amount of a bauxite grinding composition means the relative amount of bauxite grinding composition that is effective to lower viscosity of the bauxite slurry or semiliquid paste at a given application rate as compared to bauxite slurry in the absence of the bauxite grinding composition.

In one embodiment, the bauxite grinding step includes a wet grinding step where both (i) bauxite introduced into the rotating mills through a loading hopper and (ii) caustic solution returning from the hydrate precipitation zone are loaded.

Bauxite has a wetness to it typical of the mineral, which is usually increased with added recycled caustic liquor (or, in other embodiments, calcium and sodium milk or caustic soda alone) in the Bayer process disclosed herein. This combination typically generates a bauxite slurry or semi-liquid paste containing about 20% to 60% solids. In one embodiment, the bauxite slurry contains about 50% solids.

Bauxite grinding mills, in some embodiments, are cylindrical in shape and are subdivided internally into two separate chambers by a drilled diaphragm. In one embodiment, the first chamber contains grinding bars, and the second chamber contains grinding balls. In another embodiment, the grinding mill can be any combination of mills including a bar mill, a ball mill, a hammer mill, a rod mill, or any combination thereof.

In one particular embodiment, the mills contain only bars or only balls. In such embodiment, 25% to 50% of the volume of the mill is filled with the bars and with the balls, 25% to 50% of the volume is filled with the wet bauxite. The remainder of the mill is left empty to allow for efficiency of the grinding motion.

The bauxite grinding compositions as described herein, when added to the bauxite slurry, are capable of reducing the average particle size diameter or dimensions of the bauxite granules. This reduction, in some embodiments, enables more efficient extraction of the sodium aluminate by, for example, subsequent caustic etching with the concentrated solution of sodium hydroxide.

This bauxite slurry has to be pumped by the grinding mills to be able to run the subsequent steps in the Bayer process including, for example, caustic etching and/or pre-desilication. However, bauxite slurry is typically very viscous (with viscosity comprised between 1100 and 1400 cps for bauxite loads comprised between 400 and 500 tonnes/hour) and this has numerous drawbacks, as described herein.

The high viscosity of the bauxite slurry or semiliquid paste causes great power consumption by the pumps, which have to convey or move the highly viscous semiliquid paste from the mills to any number of subsequent steps of the Bayer process, for example, the processing autoclave. This decreases the overall productive capacity of the plant for obtaining alumina. Further, the presence of highly viscous bauxite slurry inside the grinding mills and pumps cakes or dirties the aforesaid machinery, making it necessary to perform numerous cleaning operations on the mills and the pumps. In addition, the presence of highly viscous bauxite slurry inside pumps produces rapid wear to said pumps.

Accordingly, the bauxite grinding compositions of the present invention may be added to the bauxite slurry via different routes. In one embodiment, the bauxite grinding composition(s) as described herein are capable of reducing the viscosity of the bauxite slurry introduced into the loading hopper of the grinding mills. In another embodiment, the bauxite grinding compositions as described herein are mixed with the liquor (e.g. spent or evaporated strong) that is added to a mill, or with a bauxite containing slurry, which is added to the mill.

In another embodiment, the bauxite grinding compositions as described herein are added to the slurry at any step prior to the digestion step. In another embodiment, the bauxite grinding compositions as described herein are added to the slurry before or during the pre-desilication step or during the grinding step. In another embodiment, the bauxite grinding compositions as described herein are added to the slurry before or during the grinding step.

The bauxite grinding compositions can significantly reduce the viscosity of bauxite slurry, which allows better handling and allows alumina refinery plants to increase throughput of bauxite grinding or pre-desilication, resulting in increased alumina production, reduced energy consumption or a combination of both. In some embodiments, the bauxite grinding composition can be added at any step of the Bayer process, including the grinding step, pre-desilication step, digestion step, decantation step, filtration step, precipitation step or calcination step, where the desired result is a decrease in viscosity of the slurry. In other embodiments, the bauxite grinding composition can be added several times over any step of the Bayer process, including the grinding step, and/or pre-desilication step, and/or digestion step, and/or decantation step, and/or filtration step, and/or precipitation step and/or calcination step, where the desired result is a decrease in viscosity of the slurry.

In other embodiments, the bauxite grinding composition can be added sequentially in any number of steps or chosen to be added at two or more steps of the Bayer process, where the desired result is a decrease in viscosity of the slurry. It is therefore understood that the term “bauxite grinding composition” is not meant as a limitation regarding step, i.e., the term is not limiting as to any step during the Bayer process (e.g., adding the composition only during the grinding step) but can be used in any step according to several embodiments as described herein. The term “bauxite grinding composition” should be given the broadest interpretation consistent with the description herein.

For example, the bauxite grinding composition may be added sequentially during the grinding step, and pre-desilication step. As another example, the bauxite grinding composition may be added sequentially during the pre-desilication step, digestion step, and decantation step, wherein the desired result is a decrease in viscosity. As another example, the bauxite grinding composition may be added at one point during the grinding step and at another point during the digestion step; or in another example, added at one point during the pre-desilication step, at another point during the digestion step, and finally at a third point during the precipitation step, wherein the desired result is a decrease in viscosity. In one embodiment, the bauxite grinding composition added after the pre-desilication step cannot be dextran.

The bauxite grinding compositions as described herein are capable of reducing the viscosity of the bauxite slurry or semiliquid paste produced in the grinding step when added in an effective amount. In one embodiment, the quantity of bauxite grinding composition added to the bauxite slurry is between about 5 ppm to about 10,000 ppm. In another embodiment, the quantity of bauxite grinding composition added to the bauxite slurry is between about 10 ppm to about 5000 ppm. In another embodiment, the quantity of bauxite grinding composition added to the bauxite slurry is between about 25 ppm to about 4000 ppm. In yet another embodiment, the quantity of bauxite grinding composition added to the bauxite slurry is between about 50 ppm to about 3000 ppm. In another embodiment, the quantity of bauxite grinding composition added to the bauxite slurry is between about 75 ppm to about 1000 ppm. In yet another embodiment, the quantity of bauxite grinding composition added to the bauxite slurry is between about 90 ppm to about 750 ppm. In yet another embodiment, the quantity of bauxite grinding composition added to the bauxite slurry is between about 100 ppm to about 500 ppm.

In one embodiment, the quantity of bauxite grinding composition added to the bauxite slurry has a lower limit of 5 ppm, or 10 ppm, or 15 ppm or 25 ppm or 50 ppm, or 75 ppm, or 90 ppm, or 100 ppm, or 150 ppm, or 200 ppm, or 400 ppm, or 800 ppm, or 1000 ppm, or 1500 ppm, or 2000 ppm, or 2500 ppm or 3000 ppm. In certain other embodiments, the quantity of bauxite grinding composition added to the bauxite slurry comprises a lower limit of 75 ppm, or 100 ppm, or 125 ppm, or 150 ppm, or 175 ppm, or 200 ppm, or 250 ppm, or 300 ppm.

In some embodiments, the quantity of bauxite grinding composition added to the bauxite slurry has an upper limit of 10,000 ppm, or 7500 ppm, or 5000 ppm or 4500 ppm or 4000 ppm, or 3500 ppm, or 3000 ppm, or 2500 ppm, or 2000 ppm, or 1500 ppm, or 1000 ppm, or 900 ppm, or 800 ppm, or 700 ppm, or 600 ppm, or 500 ppm or 400 ppm. In certain other embodiments, the quantity of bauxite grinding composition added to the bauxite slurry has an upper limit of 10,000 ppm, or 7500 ppm, or 5000 ppm or 4500 ppm or 4000 ppm, or 3500 ppm, or 3000 ppm, or 2500 ppm, or 2000 ppm, or 1500 ppm, or 1000 ppm, or 900.

The presence of the bauxite grinding composition, in some embodiments, reduces the viscosity of the bauxite slurry or semiliquid paste produced or used in the grinding step, pre-desilication step, or any step prior to the digestion step by more than 70% compared with the viscosity that said bauxite slurry or semiliquid paste would have in the absence of the bauxite grinding compositions as described herein. In other embodiments, the bauxite grinding composition reduces the viscosity of the bauxite slurry in the grinding step, pre-desilication step, or any step prior to the digestion step by more than 60% compared with the viscosity that said bauxite slurry would have in the absence of the bauxite grinding compositions as described herein.

In other embodiments, the bauxite grinding composition reduces the viscosity of the bauxite slurry in the grinding step, pre-desilication step, or any step prior to the digestion step by more than 50% compared with the viscosity that said bauxite slurry would have in the absence of the bauxite grinding compositions as described herein. In yet another embodiment, the bauxite grinding composition reduces the viscosity of the bauxite slurry in the grinding step, pre-desilication step, or any step prior to the digestion step by more than 40% compared with the viscosity that said bauxite slurry would have in the absence of the bauxite grinding compositions as described herein. In a further embodiment, the bauxite grinding composition reduces the viscosity of the bauxite slurry in the grinding step, pre-desilication step, or any step prior to the digestion step by more than 30% compared with the viscosity that said bauxite slurry would have in the absence of the bauxite grinding compositions as described herein. In yet another embodiment, the bauxite grinding composition reduces the viscosity of the bauxite slurry in the grinding step, pre-desilication step, or any step prior to the digestion step by more than 25% compared with the viscosity that said bauxite slurry would have in the absence of the bauxite grinding compositions as described herein.

In another embodiment, the bauxite grinding composition reduces the viscosity of the bauxite slurry in the grinding step, pre-desilication step, or any step prior to the digestion step by more than 20% compared with the viscosity that said bauxite slurry would have in the absence of the bauxite grinding compositions as described herein. In yet another embodiment, the bauxite grinding composition reduces the viscosity of the bauxite slurry in the grinding step, pre-desilication step, or any step prior to the digestion step by more than 10% compared with the viscosity that said bauxite slurry would have in the absence of the bauxite grinding compositions as described herein.

Said reduction of viscosity makes said semiliquid paste more flowable, facilitating the passage thereof from the grinding mills.

The grinding aid composition(s) as described herein also allow for a reduction in the electric energy consumption of pumps conveying the bauxite slurry or slurry coming from the grinding mills—to, for example, an autoclave—with an energy saving. In some embodiments, the energy saving can be up to 10%, or up to 15%, or up to 20%, or up to 25% or up to 30%.

The bauxite grinding compositions as described herein, in another embodiment, further comprises at least one surfactant. The surfactant comprises, in one embodiment, an anionic surfactant, a non-ionic surfactant, an amphoteric surfactant, a zwitterionic surfactant or a combination thereof.

Surfactants generally include but are not limited to, for example, amides such as alkanalkanolamides, ethoxylated alkanolamides, ethylene bisamides; esters such as fatty acid esters, glycerol esters, ethoxylated fatty acid esters, sorbitan esters, ethoxylated sorbitan; ethoxylates such as alkylphenol ethoxylates, alcohol ethoxylates, tristyrylphenol ethoxylates, mercaptan ethoxylates; end-capped and EO/PO block copolymers such as ethylene oxide/propylene oxide block copolymers, chlorine capped ethoxylates, tetra-functional block copolymers; amine oxides such lauramine oxide, cocamine oxide, stearamine oxide, stearamidopropylamine oxide, palmitamidopropylamine oxide, decylamine oxide; fatty alcohols such as decyl alcohol, lauryl alcohol, tridecyl alcohol, myristyl alcohol, cetyl alcohol, stearyl alcohol, oleyl alcohol, linoleyl alcohol and linolenyl alcohol; and alkoxylated alcohols such as ethoxylated lauryl alcohol, trideceth alcohols; and fatty acids such as lauric acid, oleic acid, stearic acid, myristic acid, cetearic acid, isostearic acid, linoleic acid, linolenic acid, ricinoleic acid, elaidic acid, arichidonic acid, myristoleic acid, as well as mixtures thereof. In another embodiment, the non-ionic surfactant is a glycol, glycol derivative, glycerol or glycerol derivative, such as polyethylene glycol (PEG) and butylene glycol, alkyl PEG esters, polypropylene glycol (PPG) and derivatives thereof.

Glycols, glycol derivatives, glycerols and/or glycerol derivatives include, but are not limited, to polyglycols, polyglycol derivatives, aliphatic dihydroxy (dihydric) alcohols, polypropylene glycol, triethylene glycol, butylene glycol, glycol alkyl ethers such as dipropylene glycol methyl ether, diethylene glycol. In another embodiment, glycols, glycol derivatives, glycerols and/or glycerol derivatives include but are not limited to polyglycols such as polyethylene glycols (PEG) and polypropylene glycols. Glycols are represented by the general formula CₙH2ₙ(OH)₂, where n is at least 2. Non-limiting examples of glycols include ethylene glycol (glycol), propylene glycol (1,2-propanediol), 1,4-butanediol, 1,5-pentanediol, 1,6-hexanediol, 1,7-heptanediol, 1,9-nonanediol, 1,10-decanediol, 1,8-octanediol, 1,3-propanediol, 1,3-butanediol, 1,4-butanediol, 2,3-butanediol, 2,4-pentanediol, 2,5-hexanediol, 4,5-octanediol and 3,4-hexanediol, neopenty glycol, pinacol, 2,2-diethyl-1,3-propanediol, 2-ethyl-1,3-hexanediol, 2-ethyl-2-butyl-1,3-propanediol, isobutylene glycol, 2,3-dimethyl-1,3-propanediol, 1,3-diphenyl-1,3-propanediol, 3-methyl-1,3-butanediol.

In one embodiment, the surfactant is an ethylene oxide/propylene oxide copolymer, a sufosuccinate such as dioctyl sulphosuccinate, butylene glycol, sodium alkyl ether sulfate, alkyl amido propyl betaine, alkyl iminodiproprionate such as octyl iminodiproprionate, or any combination thereof.

In one embodiment, the bauxite grinding composition comprises a co-polymer comprising a monomeric unit according to formula (I):

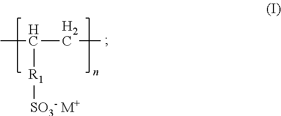

and

a monomeric unit according to formula (II):

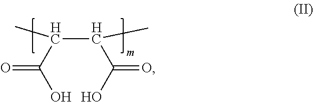

wherein R₁ is no group, O, C₁-C₁₀ alkyl, C₁-C₁₀ aryl, or C₁-C₁₀ arylalkyl;

M+ is a group I metal ion or N(R⁴)₄⁺;

R⁴ is hydrogen or an optionally substituted hydrocarbyl radical comprising from about 1 to about 20 carbons;

n is an integer of from 1-300; and

m is an integer of from 1-300.

In some embodiments, R⁴ is hydrogen or an optionally substituted C₁-C₂₀ alkyl, C₁-C₂₀ aryl, C₁-C₂₀ arylalkyl, C₁-C₁₀ alkyl, C₁-C₁₀ aryl, or C₁-C₁₀ arylalkyl.

In other embodiments, n is an integer from 1-1000; or an integer from 1-500, or an integer of from 1-300, or preferably an integer of from 1-10.

In other embodiments, m is an integer of from 1-1000, or an integer of from 1-500, or an integer of from 1-300, or preferably an integer of from 1-10.

In one particular embodiment, the bauxite grinding composition as described above is added to the slurry at any step during the Bayer process. In another embodiment, the bauxite grinding composition as described above is added to the slurry before or during the pre-desilication step or during the grinding step. In another embodiment, the bauxite grinding composition as described above is added after the grinding step, for example, on or after the digestion step.

In another embodiment, the bauxite grinding composition consists of or consists essentially of a co-polymer comprising the monomeric unit according to formula (I) and the monomeric unit according to formula (II), as described herein. In yet another embodiment, the bauxite grinding composition comprises a co-polymer comprising the monomeric unit according to formula (I) and the monomeric unit according to formula (II), as described herein, as well as any one or more of the other bauxite grinding compositions described herein.

In one embodiment, the bauxite grinding composition comprises maltitol. Maltitol (α(1→4)glucosylsorbitol) is a sugar alcohol generally used as a sweetening agent in low-caloric, dietary and low-cariogenic foods, such as confectionary products and chewing gums. Maltitol or α-D-glucopyranosyl-4-D-sorbitol is a polyol obtainable by hydrogenation of maltose.

Maltitol is exemplified by the following Formula (III):

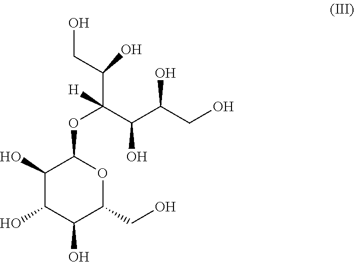 [SMILES: OC[C@@H](O)[C@@H](O[C@H]1O[C@H](CO)[C@@H](O)[C@H](O)[C@H]1O)[C@H](O)[C@@H](O)CO]

In another embodiment, the bauxite grinding composition consists of or consists essentially of maltitol. In yet another embodiment, the bauxite grinding composition comprises maltitol and any one or more of the other bauxite grinding compositions described herein.

In one particular embodiment, the bauxite grinding composition as described above is added to the slurry at any step during the Bayer process. In another embodiment, the bauxite grinding composition as described above is added to the bauxite slurry before or during the pre-desilication step or during the grinding step. In another embodiment, the bauxite grinding composition as described above is added after the grinding step, for example, on or after the digestion step.

In one embodiment, the bauxite grinding composition comprises dextran. Dextran is exemplified by the following Formula (IV):

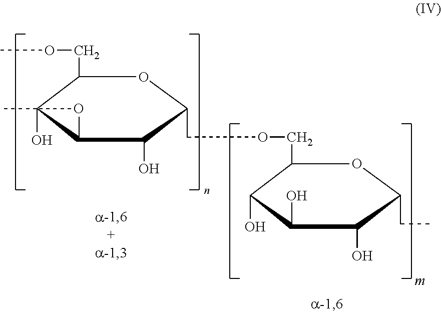

Dextran in a naturally occurring branched form contains repeating glucose units joined by α-1,6 and branched by α-1,3 glycosidic linkages. Synthetic linear dextran containing only α-1,6 linkages may be prepared from the substance levoglucosan in accordance with a known chemical synthesis.

Throughout the present disclosure the term “dextran” will be understood as referring to both or either of “linear dextran” (a dextran compound consisting of glucose units joined essentially by α-1,6 glycosidic linkages) and “branched dextran” (a dextran compound in which the glucose units are joined by α-1,6 and branched by α-1,3 glycosidic linkages).

In another embodiment, the bauxite grinding composition consists of or consists essentially of dextran. In yet another embodiment, the bauxite grinding composition comprises dextran and any one or more of the other bauxite grinding compositions described herein.

In one particular embodiment, the bauxite grinding composition as described above is added to the slurry before or during the pre-desilication step or during the grinding step. In another embodiment, the bauxite grinding composition as described above not added on or after the digestion step.

Experiments

Shanxi bauxite, Boke bauxite, Weipa bauxite, Jamaican bauxite, and Guinean bauxite were all tested (Bauxite: Sieved to 600 μm). A Brookfield DV-3T Rheometer with V-73 vane spindle was used.

General testing procedure for Shanxi bauxite, Boke bauxite, Weipa bauxite, Jamaican bauxite, Guinean bauxites:

1. The plastic beakers were charged with bauxite with or w/o CaO.

2. In a 125 mL HDPE bottler, spent strong Bayer liquor was weighed out and the appropriate amount of grinding aid/viscosity modifier sample solution was added. Typical charge was 1000 g/ton (real dose) based on bauxite (and CaO for Shanxi bauxite) charge. Agitation was applied using magnetic stirrer for about 1-2 minutes.

TABLE 1a

| | Wt % bauxite in the | Wt % of CaO in the |
|---|---|---|
| | slurry | slurry |
| Shanxi bauxite | 50 | 5 |
| Guinean bauxite | 60 | 0 |
| Jamaican bauxite | 55 | 0 |
| Boke bauxite | 65 | 0 |
| Weipa bauxite | 60 | 0 |

3. The bauxite was then added to the liquor. The wt % bauxite is shown in table 1 a. The bottle capped and shaken by hand to ensure all the bauxite was wet. The unheated blank was prepared and set aside. All the bottles were rotated in an oven (40 rpm) at room temperature for 45 min. (Maltitol was added as a 40% aqueous solution.)

4. The heating of the oven was turned on, and the temperature was set to 60° C. All bottles continued to be turned for 90 min.

5. One sample at a time was removed from the carousel and a viscosity profile was measured with the Rheometer. Once completed and the viscosity data was saved the next sample was retrieved and the profile measured.

General testing procedures for Guyana bauxite: Table 3 data.

Guyana Bauxite: Precrushed to particle sizes <300 mesh, then sieved to −100 mesh (−150 μ).

Guyana bauxite sample preparation:

1. The plastic beakers were charged with 45 grams of −150 μm Guyanese bauxite.

2. In a 125 mL HDPE bottle 67.5 grams of spent Bayer liquor was weighed out and the appropriate amount of viscosity modifier sample solution was added. Typical charge viscosity modifier was 3000 g/ton (active dose) based on bauxite charge. Agitation was applied using magnetic stirrer for about 1-2 minutes.

TABLE 1b

| | Wt % bauxite in the | Wt % of CaO in the |
|---|---|---|
| | slurry | slurry |
| Guyana bauxite | 40 | 0 |

3. The bauxite was then added to the liquor to make a 40% slurry. The wt % bauxite is shown in table 1 b. The bottle capped and shaken by hand to ensure all the bauxite was wet. The unheated blank was prepared and set aside. The bottles were individually weighed and values recorded.

4. The oven with a carousel was preheated to 80° C. The samples were placed on the oven floor for 40 min, bottle caps tightened up, and all bottles were put in the carousel to turn at 40 rpm overnight.

5. After 16 hrs at 80° C. one sample at a time was removed from the carousel and a viscosity profile was measured with the Rheometer. Once completed and the viscosity data was saved the next sample was retrieved and the profile measured. Prior to the viscosity measurement the sample was weighed and compared to the room temp weight recorded previously. The weights should be within 1 gram of each other providing evidence of no loss of liquid from the sample.

General testing procedure of viscosity profile measurement:

1. The viscosity profile measurement involves measuring the viscosity of the slurry at various spindle speeds for a specific period of time.

2. The rheometer performs the Autozero process and is ready to load the viscosity program.

3. The vane spindle (V-73) was connected to the rheometer and the program run.

Since the slurry is pseudo plastic, as the shear rate increases the viscosity, in this case, decreases.

TABLE 2
Viscosity Program Settings

| Spindle RPM | Shear Rate, 1/s | Duration, seconds |
|---|---|---|
| 10 | 2.14 | 20 |
| 20 | 4.28 | 10 |
| 30 | 6.42 | 10 |
| 40 | 8.56 | 10 |
| 50 | 10.7 | 10 |
| 75 | 16.05 | 10 |
| 100 | 21.4 | 10 |
| 150 | 32.1 | 10 |
| 200 | 42.8 | 10 |
| 250 | 53.5 | 10 |

The results were compared to the blank. The % viscosity reduction is calculated according to the following equation:

% viscosity reduction=100*(blank viscosity−sample viscosity)/blank viscosity

Screening results are shown in the following Tables 3-8.

TABLE 3
Guyana bauxite

| | | | % viscosity | % viscosity |
|---|---|---|---|---|
| | | Active | reduction at | reduction at |
| | Test compound | dose | 2.14 (1/s) | 42.8 (1/s) |
| Test compound # | structure | (ppm) | shear rate | shear rate |
| 11310 | maltitol | 3000 | 79 | 72 |
| 21239 | dextran | 3000 | 61 | 57 |
| 11239 | dextran | 3000 | 68 | 64 |

TABLE 4
Weipa bauxite

| | | | % viscosity | % viscosity |
|---|---|---|---|---|
| Test | | Active | reduction at | reduction at |
| compound | Test compound | dose | 2.14 (1/s) | 42.8 (1/s) |
| # | structure | (ppm) | shear rate | shear rate |
| 21239 | dextran | 1000 | 22 | 20 |
| CYT- | copolymer of sodium | 1000 | 27 | 23 |
| DV001 | allyl sulfonate and | | | |
| | maleic acid | | | |

TABLE 5
Shanxi bauxite

| | | | % viscosity | % viscosity |
|---|---|---|---|---|
| | | Active | reduction at | reduction at |
| | Test compound | dose | 2.14 (1/s) | 42.8 (1/s) |
| Test compound # | structure | (ppm) | shear rate | shear rate |
| 21239 | dextran | 1000 | 70 | 51 |
| 11310 | maltitol | 1000 | 81 | 73 |
| 11239 | dextran | 1000 | 89 | 79 |

TABLE 6
Jamaican bauxite

| | | | % viscosity | % viscosity |
|---|---|---|---|---|
| Test | | Active | reduction at | reduction at |
| compound | Test compound | dose | 2.14 (1/s) | 42.8 (1/s) |
| # | structure | (ppm) | shear rate | shear rate |
| 21239 | dextran | 1000 | 21 | 24 |
| 11310 | maltitol | 1000 | 35 | 32 |
| CYT- | Copolymer of sodium | 1000 | 19 | 24 |
| DV001 | allyl sulfonate and | | | |
| | maleic acid | | | |

TABLE 7
Boke bauxite

| | | | % viscosity | % viscosity |
|---|---|---|---|---|
| Test | | Active | reduction at | reduction at |
| compound | Test compound | dose | 2.14 (1/s) | 42.8 (1/s) |
| # | structure | (ppm) | shear rate | shear rate |
| 21239 | dextran | 1000 | 27 | 27 |
| 11310 | maltitol | 1000 | 28 | 25 |
| CTY- | copolymer of sodium | 1000 | 17 | n/a |
| DV001 | allyl sulfonate and | | | |
| | maleic acid | | | |

TABLE 8
Guinean bauxite

| | | | % viscosity | % viscosity |
|---|---|---|---|---|
| Test | | Active | reduction at | reduction at |
| compound | Test compound | dose | 2.14 (1/s) | 42.8 (1/s) |
| # | structure | (ppm) | shear rate | shear rate |
| 21239 | dextran | 1000 | 24 | 25 |
| 11310 | maltitol | 1000 | 19 | |
| 11239 | dextran | 1000 | 21 | |
| CYT- | Copolymer of sodium | 1000 | 13 | 12 |
| DV001 | allyl sulfonate and | | | |
| | maleic acid | | | |

The following describes the test method to determine the effectiveness of grinding aids on the predesilication of 100% Guyana bauxite.

Pre-desilication Lab Procedure used for Table 9 examples

Dry ground bauxite was combined in a 1:1 w/w ratio with strong (high alkalinity) Bayer liquor and placed in a rotating carousel water bath for 16 hours @ 80° C. Once completed, the sample was removed and the viscosity of the resulting slurry was measured using a Brookfield DV3T Rheometer and recorded. The control sample contained no viscosity modifier. When a viscosity modifier was used it was added to the 1:1 w/w ratio slurry of bauxite and Bayer liquor before it was heated. The viscosity reduction is expressed as the viscosity of the slurry containing the viscosity modifier divided by the viscosity of the slurry which does not contain the viscosity modifier after it has been heated for 16 hours at 80° C.

TABLE 9
Summary of Reagents Providing Viscosity Reduction Of
Guyanese Bauxite after Pre-desilication:

| | | | Shear | Shear |
|---|---|---|---|---|
| | | | Rate | Rate |
| | | | 16.05, | 53.5, |
| Reagent | | | 1/s | 1/s |
| Name | Structure | Dosage | % Reduction | |
| Maltitol | 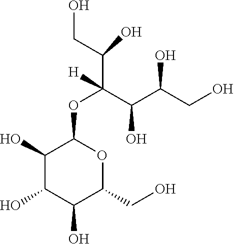 [SMILES: OC[C@@H](O)[C@@H](O[C@H]1O[C@H](CO)[C@@H](O)[C@H](O)[C@H]1O)[C@H](O)[C@@H](O)CO] | 6000 3000 1000 | 87.2 77.8 29.1 | 82.7 70.8 13.6 |

Unless indicated otherwise, concentrations of the compositions as described herein are expressed on a “real” basis (i.e., the concentrations reflect the amount of active ingredient in solution). Unless indicated otherwise, concentration units are on a weight/volume basis (i.e., percent (%) is on a g/100 mL basis, and per million (ppm) is on a weight/weight basis, g/ton of bauxite).

As used herein, the terms “a” and “an” do not denote a limitation of quantity, but rather the presence of at least one of the referenced items. “Or” means “and/or” unless clearly indicated to the contrary by the context. Recitation of ranges of values are merely intended to serve as a shorthand method of referring individually to each separate value falling within the range, and each separate value is incorporated into this specification as if it were individually recited. Thus each range disclosed herein constitutes a disclosure of any sub-range falling within the disclosed range. Disclosure of a narrower range or more specific group in addition to a broader range or larger group is not a disclaimer of the broader range or larger group. All ranges disclosed herein are inclusive of the endpoints, and the endpoints are independently combinable with each other. “Comprises” as used herein includes embodiments “consisting essentially of” or “consisting of” the listed elements.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A process to improve the grinding and handling of a bauxite containing slurry in a Bayer process comprising:
adding an effective amount of a bauxite grinding composition to the bauxite containing slurry before or during the pre-desilication step, wherein the bauxite grinding composition comprises dextran.

2. The process of claim 1 wherein the bauxite containing slurry comprises gibbsite, boehmite and diaspore.

3. The process of claim 1 wherein the bauxite grinding composition is capable of reducing the viscosity of the bauxite containing slurry by at least 10% as compared to the viscosity of a bauxite containing slurry absent the bauxite grinding composition.

4. The process of claim 1 wherein the bauxite grinding composition is capable of reducing the viscosity of the bauxite containing slurry by at least 20% as compared to the viscosity of a bauxite containing slurry absent the bauxite grinding composition.

5. The process of claim 1 wherein the bauxite grinding composition is capable of reducing the viscosity of the bauxite containing slurry by at least 30% as compared to the viscosity of a bauxite containing slurry absent the bauxite grinding composition.

6. The process of claim 1 wherein the step of adding an effective amount of a bauxite grinding composition to the bauxite containing slurry occurs during the pre-desilication step.

7. The process of claim 1 wherein the step of adding an effective amount of a bauxite grinding composition to the bauxite containing slurry occurs before or during the grinding step.

8. The process of claim 1 wherein the effective amount is in the range of about 10 ppm to about 5000 ppm.

9. The process of claim 1 wherein the effective amount is in the range of about 50 ppm to about 3000 ppm.

10. The process of claim 1 wherein the effective amount is in the range of about 100 ppm to about 500 ppm.

11. The process of claim 1 wherein the bauxite grinding composition further comprises an anionic surfactant, a non-ionic surfactant, an amphoteric surfactant, a zwitterionic surfactant or a combination thereof.

12. An undigested aqueous mineral ore slurry comprising a mineral ore and dextran in an amount effective to lower the viscosity in grinding the mineral ore.

13. The slurry of claim 12 wherein the aqueous mineral ore slurry is an aqueous aluminum ore slurry.

14. A process to improve the grinding and handling of a bauxite containing slurry in a Bayer process comprising:
adding an effective amount of a bauxite grinding composition to the bauxite containing slurry before or during the pre-desilication step, wherein the bauxite grinding composition comprises maltitol.

15. The process of claim 14 wherein the bauxite containing slurry comprises gibbsite, boehmite and diaspore.

16. The process of claim 14 wherein the bauxite grinding composition is capable of reducing the viscosity of the bauxite containing slurry by at least 10% as compared to the viscosity of a bauxite containing slurry absent the bauxite grinding composition.

17. The process of claim 14 wherein the bauxite grinding composition is capable of reducing the viscosity of the bauxite containing slurry by at least 20% as compared to the viscosity of a bauxite containing slurry absent the bauxite grinding composition.

18. The process of claim 14 wherein the bauxite grinding composition is capable of reducing the viscosity of the bauxite containing slurry by at least 30% as compared to the viscosity of a bauxite containing slurry absent the bauxite grinding composition.

19. The process of claim 14 wherein the step of adding an effective amount of a bauxite grinding composition to the bauxite containing slurry occurs before or during the grinding step.

20. The process of claim 14 wherein the step of adding an effective amount of a bauxite grinding composition to the bauxite containing slurry occurs during the pre-desilication step.

21. The process of claim 14 wherein the effective amount is in the range of about 10 ppm to about 5000 ppm.

22. The process of claim 14 wherein the effective amount is in the range of about 50 ppm to about 3000 ppm.

23. The process of claim 14 wherein the effective amount is in the range of about 100 ppm to about 500 ppm.

24. The process of claim 14 wherein the bauxite grinding composition further comprises an anionic surfactant, a non-ionic surfactant, an amphoteric surfactant, a zwitterionic surfactant or a combination thereof.

25. An undigested aqueous mineral ore slurry comprising a mineral ore and maltitol in an amount effective to lower the viscosity in grinding the mineral ore.

26. The slurry of claim 25 wherein the aqueous mineral ore slurry is an aqueous aluminum ore slurry.

27. A process to improve the grinding and handling of a bauxite containing slurry in a Bayer process comprising:
adding an effective amount of a bauxite grinding composition to the bauxite containing slurry before or during the pre-desilication step, wherein the bauxite grinding composition comprises a co-polymer comprising:
a monomeric unit according to formula (I) 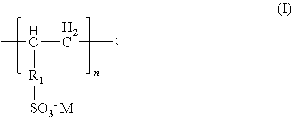
and
a monomeric unit according to formula (II) 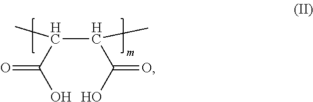
wherein R₁ is no group, O, C₁-C₁₀ alkyl, C₁-C₁₀ aryl, or C₁-C₁₀ arylalkyl;
M+ is a group I metal ion or N(R⁴)₄⁺;
R⁴ is hydrogen or an optionally substituted hydrocarbyl radical comprising from about 1 to about 20 carbons;
n is an integer from 1-300; and
m is an integer of from 1-300.

28. The process of claim 27 wherein the bauxite containing slurry comprises gibbsite, boehmite and diaspore.

29. The process of claim 27 wherein the bauxite grinding composition is capable of reducing the viscosity of the bauxite containing slurry by at least 10% as compared to the viscosity of a bauxite containing slurry absent the bauxite grinding composition.

30. The process of claim 27 wherein the bauxite grinding composition is capable of reducing the viscosity of the bauxite containing slurry by at least 20% as compared to the viscosity of a bauxite containing slurry absent the bauxite grinding composition.

31. The process of claim 27 wherein the bauxite grinding composition is capable of reducing the viscosity of the bauxite containing slurry by at least 30% as compared to the viscosity of a bauxite containing slurry absent the bauxite grinding composition.

32. The process of claim 27 wherein the step of adding an effective amount of the bauxite grinding composition to the bauxite containing slurry occurs before or during the grinding step.

33. The process of claim 27 wherein the step of adding an effective amount of the bauxite grinding composition to the bauxite containing slurry occurs during the pre-desilication step.

34. The process of claim 27 wherein the effective amount is greater than about 100 ppm.

35. The process of claim 27 wherein the effective amount is greater than about 1000 ppm.

36. The process of claim 27 wherein the effective amount is greater than about 3000 ppm.

37. The process of claim 27 wherein the effective amount is in the range of about 10 ppm to about 5000 ppm.

38. The process of claim 27 wherein the effective amount is in the range of about 50 ppm to about 3000 ppm.

39. The process of claim 27 wherein the effective amount is in the range of about 100 ppm to about 500 ppm.

40. The process of claim 27 wherein the bauxite grinding composition further comprises an anionic surfactant, a non-ionic surfactant, an amphoteric surfactant, a zwitterionic surfactant or a combination thereof.

41. An undigested aqueous mineral ore slurry comprising a mineral ore and a bauxite grinding composition in an amount effective to lower the viscosity in grinding the mineral ore, wherein the bauxite grinding composition comprises a co-polymer comprising:
a monomeric unit according to formula (I) 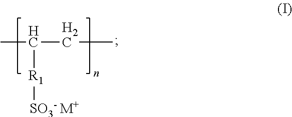
and
a monomeric unit according to formula (II) 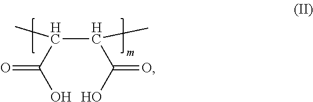
wherein R₁ is no group, O, C₁-C₁₀ alkyl, C₁-C₁₀ aryl, or C₁-C₁₀ arylalkyl;
M+ is a group I metal ion or N(R⁴)₄⁺;
R⁴ is hydrogen or an optionally substituted hydrocarbyl radical comprising from about 1 to about 20 carbons;
n is an integer from 1-300; and
m is an integer of from 1-300.

42. The slurry of claim 41 wherein the aqueous mineral ore slurry is an aqueous aluminum ore slurry.
